(19) United States
(12) Patent Application Publication
(10) Pub. No.: US 2019/0176736 A1
(43) Pub. Date: Jun. 13, 2019

(54) ACTIVE SEAT BELT CONTROL APPARATUS AND CONTROL METHOD THEREFOR

(71) Applicants: Hyundai Motor Company, Seoul (KR); Kia Motors Corporation, Seoul (KR)

(72) Inventor: Yoon Soo Jang, Suwon (KR)

(21) Appl. No.: 15/953,668

(22) Filed: Apr. 16, 2018

(30) Foreign Application Priority Data
Dec. 11, 2017 (KR) 10-2017-0168970

(51) Int. Cl. B60R 21/0132; B60R 21/0134; B60R 22/48

(52) U.S. Cl. CPC B60R 21/0132; B60R 2021/01272; B60R 22/48; B60R 21/0134

(57) ABSTRACT

An active seat belt control apparatus is controlled according to a state of a vehicle. A control method for the active seat belt control apparatus includes: collecting, by a communication unit, state information about the vehicle; determining, by a controller, whether to activate a pulling operation of a seat belt using the collected state information; and activating the pulling operation of the seat belt using a motor.

### CROSS-REFERENCE TO RELATED APPLICATION

This application claims under 35 U.S.C. § 119(a) the benefit of Korean Patent Application No. 10-2017-0168970, filed on Dec. 11, 2017, the entire contents of which are hereby incorporated by reference herein.

### BACKGROUND

### (a) Technical Field

The present disclosure relates to an active seat belt, and more particularly, to a method of controlling activation of the active seat belt according to a state of a vehicle.

### (b) Description of the Related Art

To promote safe driving, various safety devices may be installed in a vehicle to prevent collision with other vehicles. For example, a driver may be warned in advance of a potential collision with another vehicle by use of a front or rear sensor included in a forward collision avoidance (FCA) apparatus. Further, the FCA apparatus may prevent collision by activating a braking system while generating an alarm.

The vehicle may be equipped with an active seat-belt along with the FCA apparatus. A conventional active seat belt operates in operative connection with the FCA apparatus or the braking system, and may restrain the driver early by pulling the seat belt in advance in situations where a collision with another vehicle is anticipated or the driver depresses the brake pedal.

When the FCA apparatus does not generate an alarm or the vehicle is not in a braking state, the conventional active seat belt is not activated. As a result, the conventional active seat belt may fail to operate when the braking operation is not activated by the FCA apparatus or when the driver does not step on the brake pedal. Specifically, the conventional active seat belt has limitations, such as in the event that a collision with another vehicle occurs as the FCA apparatus fails or malfunctions and thus the braking operation is not activated, or as the collision is out of sight of the driver and thus the braking operation is not activated by the driver.

Therefore, there is a need for a specific method for controlling operation of the active seat belt in advance, regardless of whether or not the FCA apparatus or the brake pedal is operated.

### SUMMARY

An object of the present disclosure is to provide an active seat belt control apparatus and a control method thereof.

Another object of the present disclosure is to provide an active seat belt control apparatus capable of monitoring whether the active seat belt needs to be activated in the current driving state in real time and determining whether to activate the active seat belt to limit the behavior and/or movement of the driver in advance.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a control method for an active seat belt control apparatus may include: collecting, by a communication unit, state information about a vehicle; determining, by a controller, whether to activate a pulling operation of a seat belt using the collected state information; and activating the pulling operation of the seat belt using a motor.

According to an embodiment, the collecting of the state information may include collecting at least one of collision information received from a collision sensing apparatus, warning information received from a collision warning apparatus, buckle information received from a buckle sensor for identifying attachment/detachment of a buckle connected to the seat belt, or travel information received from a vehicle body control apparatus.

According to an embodiment, the collision sensing apparatus may include at least one of a collision acceleration sensor, an overturning acceleration sensor, an overturning angular speed sensor, an acceleration sensor, a gyro sensor, a front impact sensor, or a side impact sensor, wherein the collision warning apparatus may include at least one of a front warning sensor, a side warning sensor or a rear warning sensor, wherein the collecting of the state information may include collecting, by the vehicle body control apparatus, the state information from at least one of a yaw rate sensor, a roll rate sensor, a steering angle sensor, a wheel speed sensor or a brake pressure sensor, wherein the acceleration sensor may measure an acceleration with respect to at least one of an x-axis, a y-axis, or a z-axis.

According to an embodiment, the determining of whether to activate the pulling operation may include determining a state of the vehicle as at least one travel state using the collected state information, and determining to activate the pulling operation when the determined travel state is included in an activation mode of the seat belt, wherein the activation mode may be set to activate the pulling operation of the seat belt.

According to an embodiment, the determining of the state of the vehicle as the at least one travel state may include at least one of determining the state of the vehicle as a typical travel state, determining the state of the vehicle as a rough road travel state, determining the state of the vehicle as a front collision state, determining the state of the vehicle as a side collision state, determining the state of the vehicle as a rear collision state, determining the state of the vehicle as an overturning state, determining the state of the vehicle as a weak turning state, or determining the state of the vehicle as a strong turning state.

According to an embodiment, the activation mode may include at least one of the rough road travel state, the front collision state, the side collision state, the rear collision state, the overturning state, the weak turning state, or the strong turning state.

According to an embodiment, an intensity of the pulling operation may be set differently for each of the rough road travel state, the front collision state, the side collision state, the rear collision state, the overturning state, the weak turning state, and the strong turning state.

According to an embodiment, the control method may further include determining whether an airbag is inflated, and activating the pulling operation of the seat belt before inflation of the airbag.

According to an embodiment, the determining of whether to activate the pulling operation may include determining whether an airbag is inflated, calculating a degree of pulling of the seat belt after inflation of the airbag, and activating the pulling operation of the seat belt when the degree of pulling is greater than or equal to a threshold.

According to an embodiment, the activating of the pulling operation may include determining a degree of the pulling operation of the seat belt by the motor differently according to the state information.

According to an embodiment, the activating of the pulling operation may include determining whether a brake performs a braking operation, and activating the pulling operation of the seat belt before the braking operation of the brake.

According to an embodiment, the activating of the pulling operation may include determining whether or not a seat belt pre-tensioner is activated, and activating the pulling operation of the seat belt after activation of the seat belt pre-tensioner.

According to an embodiment, the determining of the state of the vehicle as the at least one travel state may include determining the travel state based on a change in collision speed generated by the collision acceleration sensor with respect to a distance of movement caused by a collision.

According to an embodiment, the present disclosure provides a computer-readable recording medium on which a program for executing the above-described method is recorded.

In another aspect of the present disclosure, an active seat belt control apparatus may include a communication unit configured to receive state information about a vehicle, a controller configured to determine whether to activate a pulling operation of a seat belt using the collected state information, and a motor configured to perform the pulling operation of the seat belt.

According to an embodiment, the communication unit receives at least one of collision information from a collision sensing apparatus, warning information from a collision warning apparatus, buckle information from a buckle sensor for identifying attachment/detachment of a buckle connected to the seat belt, or travel information from a vehicle body control apparatus.

According to an embodiment, the collision sensing apparatus may include at least one of a collision acceleration sensor, an overturning acceleration sensor, an overturning angular speed sensor, an acceleration sensor, a gyro sensor, a front impact sensor, or a side impact sensor, wherein the collision warning apparatus may include at least one of a front warning sensor, a side warning sensor or a rear warning sensor, wherein the vehicle body control apparatus may collect the state information from at least one of a yaw rate sensor, a roll rate sensor, a steering angle sensor, a wheel speed sensor or a brake pressure sensor, wherein the acceleration sensor may measure an acceleration with respect to at least one of an x-axis, a y-axis, or a z-axis.

According to an embodiment, the controller may be configured to determine a state of the vehicle as at least one travel state using the collected state information and to determine to activate the pulling operation when the determined travel state is included in an activation mode of the seat belt, wherein the activation mode may be set to activate the pulling operation of the seat belt.

According to an embodiment, the controller may be configured to determine the state of the vehicle as at least one of a typical travel state, a rough road travel state, a front collision state, a side collision state, a rear collision state, an overturning state, a weak turning state, or a strong turning state.

According to an embodiment, the activation mode may include at least one of the rough road travel state, the front collision state, the side collision state, the rear collision state, the overturning state, the weak turning state, or the strong turning state.

According to an embodiment, an intensity of the pulling operation may be set differently for each of the rough road travel state, the front collision state, the side collision state, the rear collision state, the overturning state, the weak turning state, and the strong turning state.

According to an embodiment, the controller may determine whether an airbag is inflated, and activate the pulling operation of the seat belt before inflation of the air bag.

According to the embodiment, the controller may determine whether an airbag is inflated, calculate degree of pulling of the seat belt after inflation of the airbag, and activate the pulling operation of the seat belt when the degree of pulling is greater than or equal to a threshold.

According to an embodiment, the controller may determine a degree of the pulling operation of the seat belt by the motor differently according to the state information.

According to an embodiment, the controller may determine whether a brake performs a braking operation, and activate the pulling operation of the seat belt before the braking operation of the brake.

According to an embodiment, the controller may determine whether or not a seat belt pre-tensioner is activated, and activate the pulling operation of the seat belt after activation of the seat belt pre-tensioner.

According to an embodiment, the controller may determine the travel state based on a change in collision speed generated by the collision acceleration sensor with respect to a distance of movement caused by a collision.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram illustrating an active seat belt control apparatus according to an embodiment of the present disclosure;

FIG. 2 is a block diagram specifically illustrating an active seat belt control apparatus according to another embodiment of the present disclosure;

FIG. 3 is a flowchart illustrating a control method for an active seat belt control apparatus according to an embodiment of the present disclosure;

FIG. 4 is a flowchart illustrating a control method for an active seat belt control apparatus according to another embodiment of the present disclosure;

FIG. 5 is a graph illustrating activation of an active seat belt in a rough road travel mode and an inflation failure situation of the airbag according to another embodiment of the present disclosure; and

FIG. 6 is a flowchart illustrating a control method for an active seat belt control apparatus according to another embodiment of the present disclosure.

### DETAILED DESCRIPTION OF THE DISCLOSURE

Hereinafter, an apparatus and various methods to which embodiments of the present disclosure are applied will be described in detail with reference to the drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

While all elements constituting embodiments of the present disclosure have been described as being connected into one body or operating in connection with each other, the disclosure is not limited to the described embodiments. That is, within the scope of the present disclosure, one or more of the elements may be selectively connected to operate. In addition, although all elements can be implemented as one independent hardware device, some or all of the elements may be selectively combined to implement a computer program having a program module for executing a part or all of the functions combined in one or more hardware devices. Code and code segments that constitute the computer program can be easily inferred by those skilled in the art. The computer program may be stored in a computer-readable storage medium, read and executed by a computer to implement an embodiment of the present disclosure. The storage medium of the computer program may include a magnetic recording medium, an optical recording medium, and a carrier wave medium.

In the description of the embodiments, it is to be understood that when an element is described as being “on” or “under” and “before” or “after” another element, it can be directly “on” or “under” and “before” or “after” another element or can be indirectly formed such that one or more other intervening elements are also present between the two elements.

All terms, including technical and scientific terms, have the same meaning as commonly understood by one of ordinary skill in the art to which this disclosure pertains, unless otherwise defined. Commonly used terms, such as those defined in typical dictionaries, should be interpreted as being consistent with the contextual meaning of the relevant art, and are not to be construed in an ideal or overly formal sense unless expressly defined to the contrary.

In describing the components of the present disclosure, terms such as first, second, A, B, (a), and (b) may be used. These terms are used only for the purpose of distinguishing one constituent from another, and the terms do not limit the nature, order or sequence of the components. When one component is said to be “connected,” “coupled” or “linked” to another, it should be understood that this means the one component may be directly connected or linked to another one or another component may be interposed between the components.

In describing embodiments disclosed in this specification, a detailed description of relevant well-known technologies apparent to those skilled in the art may be omitted in order not to obscure the subject matter of the present disclosure.

When an accident occurs, the fastening status of a seat belt has a significant effect on the degree of injury of the driver and/or passengers. Even if the airbag is inflated, the driver who is not fastening the seat belt could be thrown out of the vehicle due to the inertia during travel of the vehicle. Therefore, the seat belt is an essential device installed in the vehicle to ensure safety of the driver or passengers.

The active seat belt may actively operate to ensure safety depending on travel situations. The active seat belt may limit the driver's behavior and/or movement by being tensioned before a crash. The active seat belt may actively determine the travel condition of the vehicle in order to operate before a crash.

The active seat belt may operate in conjunction with the brake or the FCA apparatus. If sudden braking is activated or a collision is anticipated from the FCA apparatus, the active seat belt may be momentarily tensioned to bring the driver's body into close contact with the seat. Thereby, the effect of the airbag may be further enhanced, and the airbag may be prevented from causing injury.

The conventional active seat belt may not operate when emergency braking is not activated by the FCA apparatus or when the driver does not step on the brake pedal. Specifically, the conventional active seat belt has limitations such as in the event that a collision with another vehicle occurs as the FCA apparatus fails or malfunctions and thus the emergency braking is not activated, or as the collision is out of sight of the driver and thus braking is not activated by the driver.

The active seat belt control apparatus according to an embodiment of the present disclosure may monitor whether the active seat belt needs to be activated in the current travel state in real time regardless of operation of the FCA apparatus or the brake pedal, and determine whether to operate to limit the behavior and/or movement of the driver in advance.

The active seat belt control apparatus according to an embodiment of the present disclosure may monitor the state information about the vehicle in real time, thereby attenuating sagging caused by the behavior of the driver even after operation of the pre-tensioner. Safety of the driver may be more effectively ensured in a secondary accident.

The active seat belt control apparatus according to an embodiment of the present disclosure may be allowed to be tightened in various situations where the behavior and/or movement of the driver needs to be limited, including a collision without inflation of the airbag or travel along a rough road. Therefore, protection of the driver may be enhanced.

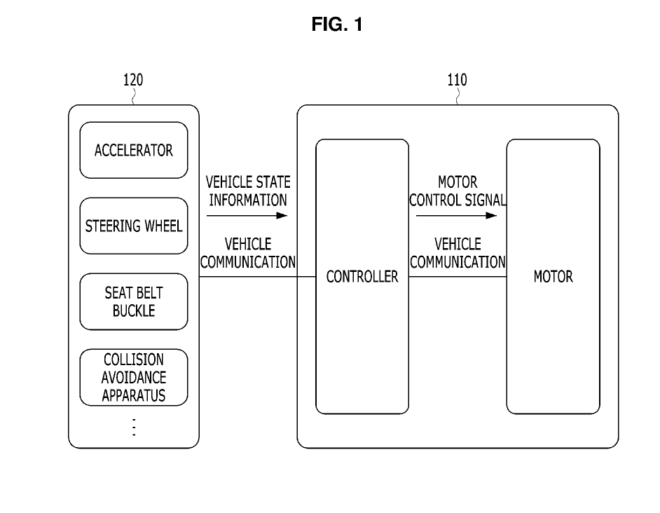

FIG. 1 is a block diagram illustrating an active seat belt control apparatus according to an embodiment of the present disclosure.

Referring to FIG. 1, an active seat belt control apparatus 110 may receive state information about the vehicle from at least one sensor 120 mounted in the vehicle. The active seat belt control apparatus 110 may be connected to each of the at least one sensor 120 via vehicle communication.

The vehicle communication technologies may include, but are not limited to, controller area network (CAN), local interconnect network (LIN), FlexRay, media oriented system transport (MOST), and hard-wire communication.

The active seat belt control apparatus 110 may include a motor connected to an end of the seat belt, and may operate the motor to pull the seat belt connected to the motor to limit the behavior and/or movement of the driver.

The motor may fix the end of the seat belt to position the seat belt with a certain length in a wound state. Upon receiving a motor control signal from a controller, the motor may pull, in the normal direction, the seat belt loosened in the reverse direction by the driver to bring the driver into close contact with the seat.

The active seat belt control apparatus 110 may operate in conjunction with an airbag, a brake or an FCA apparatus. Specifically, when the airbag is inflated due to a collision, or the driver suddenly steps on the brake pedal (emergency braking), the active seat belt control apparatus 110 may receive information of a sensor (for example, front radar) included in the FCA apparatus and send a motor control signal to the motor to pull the seat belt. When the motor receives the signal instructing pulling of the seat belt and pulls the seat belt, the active seat belt control apparatus 110 may bring the driver's body into close contact with the seat to ensure safety.

According to an embodiment, the active seat belt control apparatus 110 may operate in conjunction with a side collision avoidance system or a rearward collision avoidance apparatus in addition to the FCA apparatus. When the active seat belt controller 110 receives a signal for a dangerous situation determined by the FCA apparatus, the side collision avoidance apparatus, or the rearward collision avoidance apparatus, it may activate the pulling operation immediately before the collision, thereby strongly pulling the seat belt to secure a safe position of the driver.

When collision with another vehicle is sensed or the control function of the vehicle is determined to be lost through a sensor such as a radar system, the FCA apparatus, the side collision avoidance apparatus or the rearward collision avoidance apparatus may transmit a signal for determination of a dangerous situation to the active seat belt control apparatus 110.

According to an embodiment, the active seat belt control apparatus 110 may pull the seat belt in order to secure driving safety in the case where the driver lurches to one side due to sudden braking, sudden turning, or the like during travel of the vehicle. Specifically, when the upper body of the driver lurches forward due to sudden braking or lurches to the left and right due to sudden turning, the active seat belt control apparatus 110 may activate the pulling operation to strongly pull the seat belt to secure a safer position of the driver.

In addition, when it is determined that the vehicle is traveling on a slippery road, such as an icy road, or a rough road, the active seat belt control apparatus 110 may activate the pulling operation to secure driving safety.

According to an embodiment, the active seat belt control apparatus 110 may pull and tighten the seat belt if the seat belt is not in contact with the driver's body but is loose.

The active seat belt control apparatus 110 may calculate the degree of slackness (hereinafter, slack) of the seat belt, and may monitor occurrence of slack and pull the seat belt to remove the slack.

The active seat belt control apparatus 110 may automatically rewind the seat belt in the normal direction when the seat belt is released from the buckle.

In addition, the active seat belt control apparatus 110 according to an embodiment of the present disclosure may transmit, to the motor, a motor control signal for pulling the seat belt according to a travel state of the vehicle, regardless of inflation of the airbag, and operations of the brake and the FCA apparatus, thereby limiting the driver's behavior and/or movement according to the situation.

In order to actively operate according to the travel state of the vehicle regardless of inflation of the airbag, and operations of the brake and the FCA apparatus, the active seat belt control apparatus 110 may collect state information about the vehicle from at least one sensor 120 mounted on the vehicle and determine whether to activate the active seat belt using the collected state information about the vehicle.

In the event of collision without inflation of the airbag, or travel along a path where driving safety is required (for example, a rough road such as an icy or unpaved road), the active seat belt needs to be pulled to bring the driver's body into close contact with the seat.

Even when the airbag is not inflated or it is determined that the vehicle is traveling on a rough road, the active seat belt control apparatus 110 may secure safety by limiting the behavior and/or movement of the driver by pulling the seat belt. In other words, the active seat belt control apparatus 110 may secure safety by limiting the behavior and/or movement of the driver by pulling the seat belt in the event of collision recorded in an event data recorder (EDR), rearward collision, travel on a rough road, and failure of inflation of the airbag, and a case where a secondary accident has not yet occurred after the airbag was inflated due to collision.

The state information about the vehicle received by the active seat belt control apparatus 110 may include accelerator position sensor (APS) information indicating the degree of depression of the accelerator, steering angle information about the steering wheel, buckle information received from a buckle sensor configured to identify attachment/detachment of a buckle connected to the seat belt, and a signal for determination of a dangerous situation generated by a collision avoidance apparatus.

The value of the APS information may vary depending on the degree of manipulation of the accelerator pedal by the driver, and may be used to calculate the speed or acceleration of the vehicle.

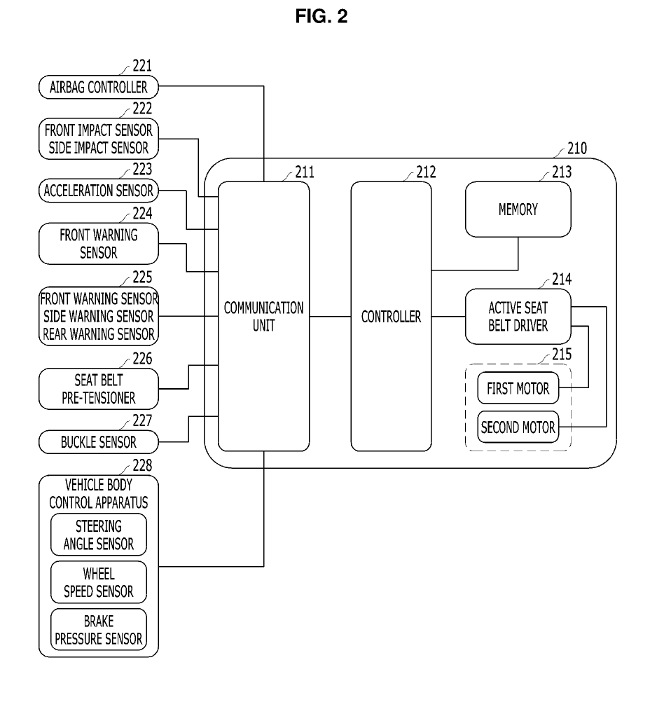

FIG. 2 is a block diagram specifically illustrating an active seat belt control apparatus according to another embodiment of the present disclosure.

Referring to FIG. 2, the active seat belt control apparatus 210 may include a communication unit 211 configured to receive state information about the vehicle information from at least one sensor 221 to 228 mounted in the vehicle, a controller 212 configured to determine whether to activate the pulling operation of the seat belt using the state information, a memory 213 configured to store conditions for activating the seat belt, an active seat belt driver 214 configured to transmit a motor control signal of the controller 212 to a motor 215, and the motor 215 connected to the seat belt to directly perform the pulling operation. The elements shown in FIG. 2 are not essential, and thus the active seat belt control apparatus 210 may be implemented with more or fewer components.

The communication unit 211 may be connected to the at least one sensor 221 to 228 mounted on the vehicle via vehicle communication and receive the state information about the vehicle required to determine whether to pull the seat belt from the at least one sensor 221 to 228.

The communication unit 211 may receive at least one of collision information from a front impact sensor or a side impact sensor 222 included in a collision sensing apparatus, warning information from a front warning sensor, a side warning sensor or a rear warning sensor 225 included in a collision warning apparatus, buckle information from a buckle sensor 227 configured to identify attachment/detachment of a buckle connected to the seat belt, or travel information from a vehicle body control apparatus 228.

The collision sensing apparatus may include a front impact sensor or a side impact sensor 222 and may include at least one of a collision acceleration sensor, an overturning acceleration sensor, an overturning angular speed sensor, an acceleration sensor, a gyro sensor, a front impact sensor, a side impact sensor, or a rear impact sensor.

The collision sensing apparatus may include an accelerometer-type acceleration sensor or a pressure-type acceleration sensor. The accelerometer-type acceleration sensor may include a front impact sensor (FIS) or a side impact sensor (SIS). The accelerometer-type acceleration sensor may perform PSIS protocol communication. The FIS may be mounted on a front-end module of vehicle, and the SIS may be mounted on the B/C-pillar.

The pressure-type acceleration sensor may include a pressure sensor and may be mounted on the door next to the driver's seat or a front passenger seat.

The collision sensing apparatus may include a front or side impact sensor, and may sense impact applied to the vehicle at the beginning of the collision and deliver the information to the active seat belt control apparatus 210.

According to an embodiment, the collision sensing apparatus may include a pressure side impact sensor (PSIS) to sense side collision. The PSIS may be mounted to a side portion of the vehicle. According to an embodiment, the PSIS may be installed mainly in the door by the driver's seat and the door by the front passenger seat. When the door is deformed due to side collision, the PSIS may sense pressure change occurring instantaneously inside the door and transmit the pressure change to the active seat belt control apparatus.

The collision warning apparatus may include at least one of a front warning sensor, a side warning sensor, or a rear warning sensor 225. According to an embodiment, the side warning sensor may be mounted in a lane keeping assist system (LKAS), and the rear warning sensor may be mounted in a blind spot warning (BSW) apparatus or a rear-end collision warning (RCW) apparatus.

The vehicle body control apparatus 228 may include at least one of a yaw rate sensor, a roll rate sensor, a steering angle sensor, a wheel speed sensor, or a brake pressure sensor, and the acceleration sensor may measure the acceleration with respect to at least one of the x-axis, the y-axis, or the z-axis.

According to an embodiment, the controller 212 may use the yaw rate sensor and an inertial measurement unit (IMU) composed of Ax and Ay acceleration sensors to determine the degree of behavior such as turning of the vehicle.

According to an embodiment, the controller 212 may use a roll rate sensor and an overturning sensor unit including Ay and Az acceleration sensors to determine the overturning state of the vehicle.

According to an embodiment, the controller 212 may utilize a main impact sensor mounted inside the airbag controller 221 or the front or side impact sensor mounted outside the vehicle to determine a front or side collision state in order to determine front or side collision and rough road travel. After determining front or side collision, the controller 212 may transmit, to the airbag controller 221, a signal for instructing inflation of the airbag.

The controller 212 may determine overturning or turning of the vehicle using information from the overturning acceleration sensor or the overturning angular speed sensor, steering angle information, a vehicle speed, and brake pressure information. According to an embodiment, the turning state may be classified into weak turning or strong turning, and the intensity of the pulling operation may differ between the weak turning state and the strong turning state.

The controller 212 may determine whether to activate the pulling operation of the seat belt, using the collected state information.

Specifically, the controller 212 may determine the state of the vehicle as at least one travel state using the collected state information, and may determine to activate the pulling operation when the determined travel state is included in the activation mode of the seat belt. The activation mode may be defined as a mode in which the pulling operation of the seat belt is set to be activated.

The controller 212 may determine the state of the vehicle as at least one of a typical travel state, a rough road travel state, a front collision state, a side collision state, a rear collision state, an overturning state, a weak turning state, or a strong turning state.

The controller 212 may determine the travel state on the basis of the collision speed change obtained by the collision acceleration sensor with respect to the distance of movement according to collision.

The controller 212 may determine whether the determined travel state of the vehicle corresponds to the active mode. According to an embodiment, the activation modes may include at least one of a rough road travel state, a front collision state, a side collision state, a rear collision state, an overturning state, a weak turning state, or a strong turning state.

The activation modes may be stored in the memory 213 and the controller 212 may determine whether the determined travel state corresponds to one of the activation modes by referring to the memory 213.

The controller 212 may set the intensity of the pulling operation differently for each travel state that activates the pulling operation of the seat belt. In other words, the intensity of the pulling operation may differ among the rough road travel state, the front collision state, the side collision state, the rear collision state, the overturning state, the weak turning state, and the strong turning state.

The controller 212 may determine whether the airbag is inflated, and activate the pulling operation of the seat belt before inflation of the air bag. The communication unit 211 may receive information on whether the airbag is inflated from an airbag controller (ACU).

The airbag controller (ACU) is a control apparatus that receives impact information detected by the front and side impact sensors of the vehicle to determine whether to inflate the airbag or issue an inflation command.

The controller 212 may determine whether the airbag is inflated, calculate the degree of tension of the seat belt after inflation of the airbag, and activate the pulling operation of the seat belt if the degree of tension is greater than or equal to a threshold value.

The controller 212 may determine whether braking is applied and activate the pulling operation of the seat belt before braking is applied. The communication unit 211 may receive information generated by the brake pressure sensor from the vehicle body control apparatus 228.

The controller 212 may determine whether the seat belt pre-tensioner 226 is activated, and activate the pulling operation of the seat belt after activating the seat belt pre-tensioner. The communication unit 211 may receive information on whether or not the seat belt pre-tensioner 226 is activated. In other words, the active seat belt control apparatus 210 may eliminate the degree of looseness (slack) of the seat belt that may occur after the pulling operation of the seat belt pre-tensioner 226, thereby bringing the body into close contact with the seat.

The seat belt pre-tensioner is similar in purpose and function to the active seat belt, but differs from the active seat belt in operation. Unlike the active seat belt, which is pulled using a motor, the seat belt pre-tensioner may pull the seat belt using gunpowder as in the case of the airbag.

According to the difference in configuration mentioned above, the seat belt pre-tensioner is for one-time use, and cannot adjust the degree of pulling. Accordingly, it is difficult for the seat belt pre-tensioner to remove slack caused by the behavior of the driver, and to perform a function for convenience such as a driver assistance function in a situation where the vehicle travels on a rough road. In addition, the seat belt pre-tensioner has a disadvantage in that it needs to be replaced with a new one once it is inflated like the airbag.

In the event that a collision accident occurs, causing inflation of the airbag, the seat belt pre-tensioner 226 may be operated, but slack of the seat belt may occur due to the behavior of the driver occurring at the time of collision. At this time, if secondary collision occurs, the seat belt pre-tensioner 226, which performs a one-time operation, may not be operated and the driver may suffer a problem regarding safety due to the slack occurring after the operation of the seat belt pre-tensioner 226. The operation of the active seat belt control apparatus 210, which is an embodiment of the present disclosure, may improve safety of the driver.

The active seat belt driver 214 may be software that may control the motor, which is hardware to directly execute the command of the controller 212. The active seat belt driver 214 may connect the controller 212 with the motor, which is a hardware unit, and may be an application that mediates interaction between the motor and the controller.

The active seat belt driver 214 may receive a motor control signal from the controller 212 and thus directly control the motor 215, and may report the control state of the motor 215 to the controller 212 through vehicle communication.

The motor 215 may include a plurality of motors depending on the number of seat belts mounted in the vehicle. According to an embodiment, the motor may include a first motor positioned close to the driver's seat and a second motor positioned close to the front passenger seat. According to an embodiment, the first motor may be a left-hand (LH) motor and the second motor may be a right-hand (RH) motor.

The motor 215 may be controlled by controlling the current of the active seat belt driver 214. Specifically, the active seat belt driver 214 may control the motor 215 by transmitting a current signal or a PWM-modulated current signal to the first motor or the second motor.

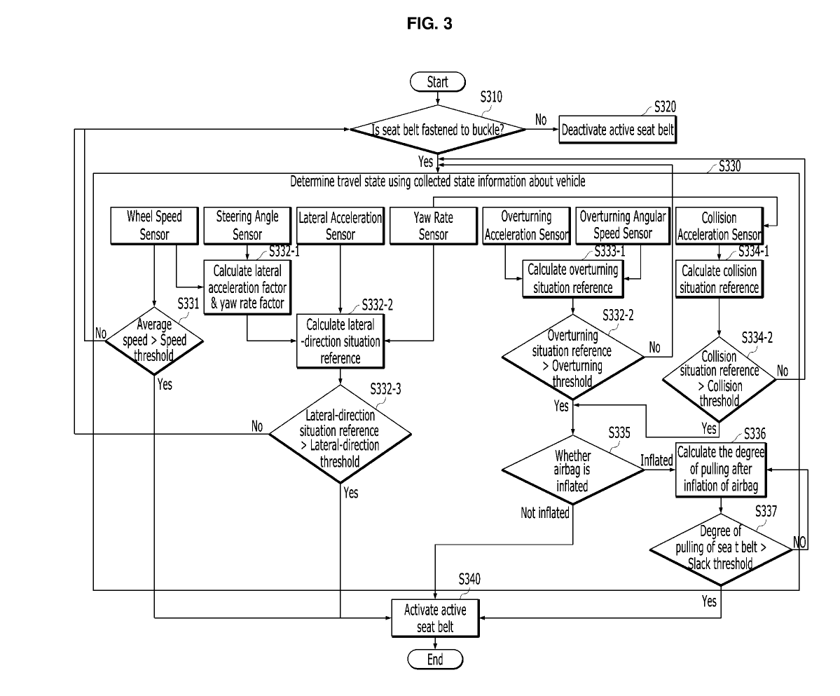

FIG. 3 is a flowchart illustrating a control method for an active seat belt control apparatus according to an embodiment of the present disclosure.

Referring to FIG. 3, the active seat belt control apparatus may activate the active seat belt when the vehicle is in a turning state, an overturning state, or a rough road travel state.

The active seat belt control apparatus may determine whether the seat belt is fastened to the buckle of the seat belt by using the information generated from the buckle sensor (S310). If the seat belt is not fastened, the pulling operation may be deactivated (S320).

If the active seat belt is fastened (“Yes” in S310), the active seat belt control apparatus may determine the travel state of the vehicle using the collected state information about the vehicle (S330).

The active seat belt control apparatus may receive the state information from the wheel speed sensor, the steering angle sensor, the lateral acceleration sensor, the yaw rate sensor, the overturning acceleration sensor, and the overturning angular speed sensor.

The active seat belt control apparatus may calculate the average speed for a predetermined time or for every certain distance, using the wheel speed sensor, and activate the active seat belt when the average speed exceeds a speed threshold (“Yes” in S331) (S340). If the vehicle travels at a speed higher than a certain speed, the active seat belt needs to be activated because the inertial force may be stronger when an accident occurs.

The active seat belt control apparatus may calculate a lateral acceleration factor or a yaw rate factor using the wheel speed sensor and the steering angle sensor (S332-1). The active seat belt control apparatus may compute a lateral-direction situation reference using the calculated factor and the information generated from the lateral acceleration sensor or the yaw rate sensor. The lateral-direction situation reference may be a parameter indicating the degree of turning when the vehicle travels.

If the lateral-direction situation reference exceeds a lateral-direction threshold, the active seat belt control apparatus may determine that the vehicle is in a considerable turning state (S332-3) and activate the active seat belt (S340).

According to an embodiment, there may be a plurality of lateral-direction thresholds. If the lateral-direction situation reference is greater than a first lateral-direction threshold and less than a second lateral-direction threshold, it may be determined that the vehicle is in a weak turning state. If the lateral-direction situation reference is greater than the second lateral-direction threshold, it may be determined that the vehicle is in a strong turning state.

The active seat belt control apparatus may apply a different pulling intensity in response to the weak turning state or the strong turning state.

The active seat belt control apparatus may calculate an overturning situation reference using the overturning acceleration sensor or the overturning angular speed sensor (S333-1). When the overturning situation reference exceeds a preset overturning threshold (S333-2), the active seat belt control apparatus may determine the operation of the active seat belt differently depending on whether or not the airbag is inflated.

If the overturning situation reference exceeds the preset overturning threshold (S333-2), the active seat belt control apparatus may activate the active seat belt to ensure safety of the driver even if the airbag is not inflated.

If the overturning situation reference exceeds the preset overturning threshold (S333-2) while the airbag is inflated (“Inflated” in S335), the degree of pulling may be calculated to calculate the degree of slack of the seat belt after inflation of the airbag. If the degree of pulling exceeds a preset slack threshold, the active seat belt control apparatus may activate the active seat belt, determining that the seat belt is slack (S340).

The active seat belt control apparatus may determine that the vehicle is in a preset rough travel state, a preset front impact state, a preset side impact state, or a preset rear impact state using a collision acceleration sensor or a yaw rate sensor. The active seat belt control apparatus may calculate a front collision situation reference, a side collision situation reference, a rear collision situation reference, and a rough road travel situation reference, respectively (S334-2).

If at least one of the front collision situation reference, the side collision situation reference, the rear collision situation reference, or the rough road travel situation reference exceeds a preset collision threshold, the active seat belt control apparatus may determine the operation of the active seat belt differently depending on whether or not the airbag is inflated.

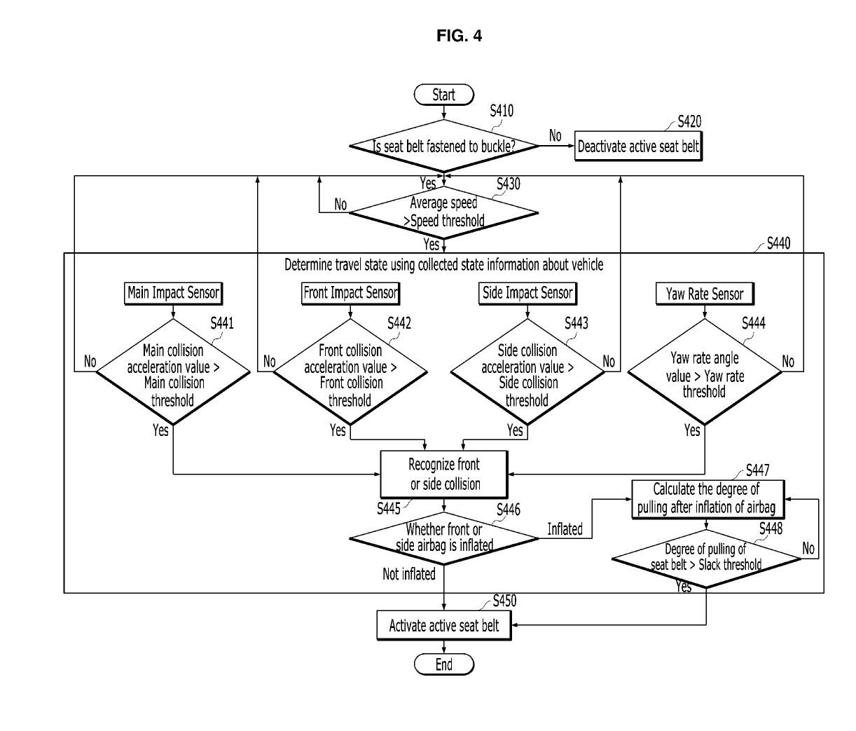

FIG. 4 is a flowchart illustrating a control method for an active seat belt control apparatus according to another embodiment of the present disclosure.

Referring to FIG. 4, the active seat belt control apparatus may activate the active seat belt even in the case where the vehicle is traveling on a rough road, or is subjected to collision without the airbag inflated.

The active seat belt control apparatus may determine whether the seat belt is fastened to the buckle of the seat belt, using the information generated by the buckle sensor (S410). If the seat belt is not fastened, the pulling operation of the active seat belt control apparatus may be deactivated (S420).

If the active seat belt is fastened (“Yes” in S310), the active seat belt control apparatus may activate the active seat belt only when the average speed of the vehicle exceeds a speed threshold. The active seat belt control apparatus may use the wheel speed sensor to determine if the average speed of the vehicle exceeds a preset speed threshold.

If the average speed of the vehicle exceeds the speed threshold (“Yes” in S430), the active seat belt control apparatus may determine the travel state using the collected state information about the vehicle.

The active seat belt control apparatus may determine a collision state of the vehicle, using the main impact sensor, the front impact sensor, the side impact sensor, and the yaw rate sensor included in the airbag controller.

If the main collision acceleration value generated by the main impact sensor exceeds a preset main collision threshold (“Yes” in S441), the front collision acceleration value generated by the front impact sensor exceeds a preset front collision threshold (“Yes” in S442), the side collision acceleration value generated by the side impact sensor exceeds a preset side collision threshold (“Yes” in S443), or the yaw rate angle value generated by the yaw rate sensor exceeds a preset yaw rate threshold (“Yes” in S444), the active seat belt control apparatus may recognize front or side collision with another vehicle (S445).

Even if front or side collision with another vehicle is recognized, the airbag may not be inflated, the active seat belt control apparatus may determine whether to activate the active seat belt based on whether any of the plurality of airbags located on the front or side is inflated (S446).

Even if the airbag is not inflated, the behavior and/or movement of the driver caused by collision needs to be limited. Therefore, if the values produced by the respective sensors exceed the corresponding thresholds, the active seat belt control apparatus may activate the active seat belt to ensure safety of the driver.

If the values produced by each sensor exceed the corresponding thresholds and the airbag is inflated (“Inflated” in S446), the degree of pulling may be calculated to calculate the degree of slack of the seat belt after inflation of the airbag. If the degree of pulling exceeds a preset slack threshold (“Yes” in S448), the active seat belt control apparatus may determine that the seat belt is loose, and activate the active seat belt (S450).

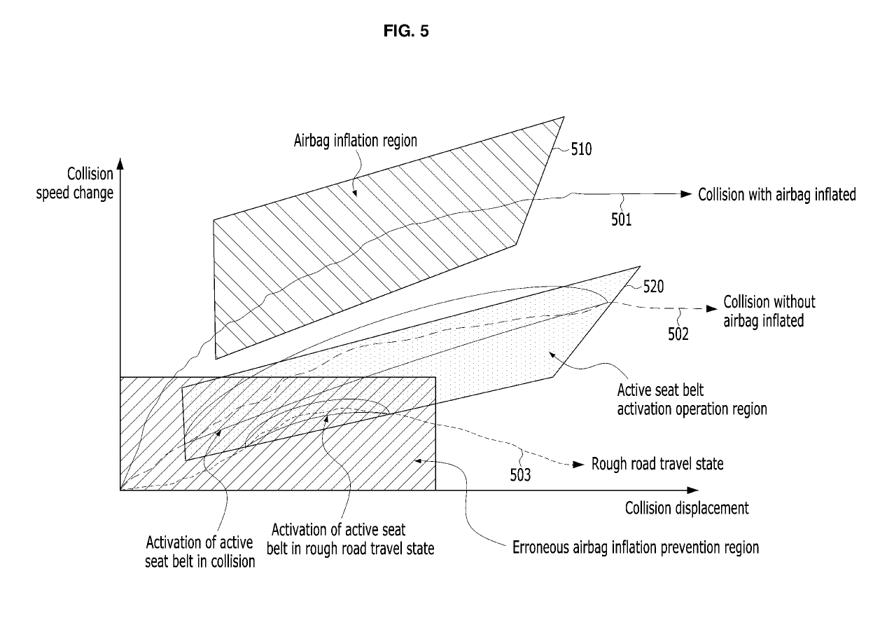

FIG. 5 is a graph illustrating activation of an active seat belt in a rough road travel mode and an inflation failure situation of the airbag according to another embodiment of the present disclosure.

Referring to FIG. 5, the threshold for activating the active seat belt in the front, side, or rear collision state or the rough road travel state may be set using a collision displacement and change in collision speed. The collision displacement and the change in collision speed may be calculated using the main impact sensor, the front impact sensor, the side impact sensor, or the rear impact sensor. The collision displacement may be a dimension corresponding to a distance which the vehicle moves in the event of collision.

The threshold for activating the active seat belt may be stored in memory and may be changed by the administrator depending on the travel environment of the vehicle.

In other words, on the collision speed change-collision displacement graph, the boundary value 510 of the inflated mode and the non-inflated mode of the airbag and the boundary value 520 of activation and deactivation of the active seat belt may be set differently according to the characteristics of the vehicle and the travel environment.

The boundary value 510 of the inflated mode and the non-inflated mode of the airbag and the boundary value 520 of activation and deactivation of the active seat belt may be set using the collision speed change (Y-axis) and the collision displacement (X-axis).

Using the state information about the vehicle, the active seat belt control apparatus may determine whether the vehicle is in a collision state 501 with the airbag inflated, in a collision state 502 without the airbag inflated, or in a rough road travel state in which the active seat belt is activated only in a certain section without the airbag inflated.

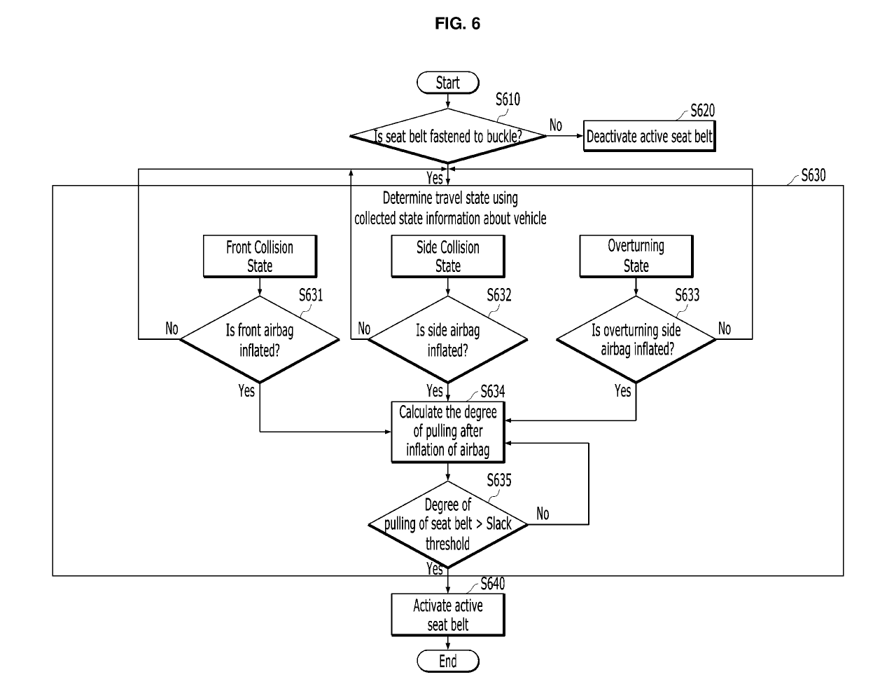

FIG. 6 is a flowchart illustrating a control method for an active seat belt control apparatus according to another embodiment of the present disclosure.

Referring to FIG. 6, the active seat belt control apparatus may activate the active seat belt to protect the driver after the airbag is inflated in a collision state.

Using the information generated by the buckle sensor, the active seat belt control apparatus may determine whether the seat belt is fastened to the buckle of the seat belt (S610). If the seat belt is not fastened, the pulling operation of the active seat belt may be deactivated (S620).

If the active seat belt is fastened (“Yes” in S610), the active seat belt control apparatus may determine the travel state of the vehicle using the collected state information about the vehicle (S630).

If the front airbag, the side airbag or the overturn side airbag is inflated due to front or side collision with another vehicle (“Yes” in S631, S632 or S633), the degree of pulling of the seat belt may be calculated to calculate the degree of slack after inflation of the airbag (S634).

The degree of pulling may be calculated according to the degree of winding or release of the seat belt connected to the motor. According to an embodiment, the degree of pulling may be calculated according to how much the seat belt is released after a preset time from a reference position at the time when the seat belt is pulled by primary collision.

If the degree of pulling exceeds a preset slack threshold (“Yes” in S635), the active seat belt control apparatus may determine that the seat belt is slack, and thus activate the active seat belt (S640).

The method according to the embodiments of the present disclosure disclosed above may be implemented as a program to be executed on a computer and stored in a computer-readable recording medium. Examples of the computer-readable recording medium include ROM, RAM, CD-ROM, magnetic tapes, floppy disks, and optical data storage devices, and also include carrier-wave type implementation (e.g., transmission over the Internet).

The computer-readable recording medium may be distributed to a computer system connected over a network, and computer-readable code may be stored and executed thereon in a distributed manner Functional programs, code, and code segments for implementing the method described above may be easily inferred by programmers in the art to which the embodiments pertain.

As apparent from the above description, an active seat belt control apparatus and a control method therefor according to embodiments of the present disclosure have the following effects.

First, as described herein, whether to activate the active seat belt may be determined regardless of whether the FCA apparatus or the brake is activated or not. Thus, in various situations where it is necessary to limit the behavior and/or movement of the driver, pulling of the seat belt may be activated.

Second, as described herein, sagging caused by the behavior of the driver after operation of a pre-tensioner, which operates as the airbag is inflated, may be attenuated, and thus safety of the driver may be more effectively ensured in a secondary accident.

Third, as described herein, the active seat belt may be allowed to be tightened in various situations where the behavior and/or movement of the driver needs to be limited, including a collision without inflation of the airbag or travel along a rough road. Therefore, protection of the driver may be enhanced.

It will be appreciated by those skilled in the art that that the effects that can be achieved through the embodiments of the present disclosure are not limited to those described above and other effects of the present disclosure will be more clearly understood from the following detailed description.

It is apparent to those skilled in the art that the present disclosure can be embodied in specific forms other than those set forth herein without departing from the spirit and essential characteristics of the present disclosure.

Therefore, the above embodiments should be construed in all aspects as illustrative and not limitative. The scope of the disclosure should be determined by the appended claims and their legal equivalents, and all changes coming within the meaning and equivalency range of the appended claims are intended to be embraced therein.

What is claimed is:

1. A control method for an active seat belt control apparatus, comprising:
collecting, by a communication unit, state information about a vehicle;
determining, by a controller, whether to activate a pulling operation of a seat belt using the collected state information; and
activating the pulling operation of the seat belt when the controller receives a signal for a dangerous situation.

2. The control method according to claim 1, wherein the collecting of the state information comprises:
collecting at least one of collision information received from a collision sensing apparatus, warning information received from a collision warning apparatus, buckle information received from a buckle sensor for identifying attachment/detachment of a buckle connected to the seat belt, or travel information received from a vehicle body control apparatus.

3. The control method according to claim 2, wherein the collision sensing apparatus comprises at least one of a collision acceleration sensor, an overturning acceleration sensor, an overturning angular speed sensor, an acceleration sensor, a gyro sensor, a front impact sensor, or a side impact sensor,
wherein the collision warning apparatus comprises at least one of a front warning sensor, a side warning sensor or a rear warning sensor,
wherein the collecting of the state information comprises:
collecting, by the vehicle body control apparatus, the state information from at least one of a yaw rate sensor, a roll rate sensor, a steering angle sensor, a wheel speed sensor or a brake pressure sensor,
wherein the acceleration sensor measures an acceleration with respect to at least one of an x-axis, a y-axis, or a z-axis.

4. The control method according to claim 2, wherein the determining of whether to activate the pulling operation comprises:
determining a state of the vehicle as at least one travel state using the collected state information; and
determining to activate the pulling operation when the determined travel state is included in an activation mode of the seat belt,
wherein the activation mode is set to activate the pulling operation of the seat belt.

5. The control method according to claim 4, wherein the determining of the state of the vehicle as the at least one travel state comprises at least one of:
determining the state of the vehicle as a typical travel state;
determining the state of the vehicle as a rough road travel state;
determining the state of the vehicle as a front collision state;
determining the state of the vehicle as a side collision state;
determining the state of the vehicle as a rear collision state; or
determining the state of the vehicle as an overturning state.

6. The control method according to claim 5, wherein the activation mode comprises at least one of the rough road travel state, the front collision state, the side collision state, the rear collision state, the overturning state, the weak turning state, or the strong turning state.

7. The control method according to claim 6, wherein an intensity of the pulling operation is set differently for each of the rough road travel state, the front collision state, the side collision state, the rear collision state and the overturning state.

8. The control method according to claim 1, further comprising:
determining whether an airbag is inflated; and
activating the pulling operation of the seat belt before inflation of the airbag.

9. The method according to claim 1, wherein the determining of whether to activate the pulling operation comprises:
determining whether an airbag is inflated;
calculating a degree of pulling of the seat belt after inflation of the airbag; and
activating the pulling operation of the seat belt when the degree of pulling is greater than or equal to a threshold.

10. The control method according to claim 1, wherein the activating of the pulling operation comprises:
determining a degree of the pulling operation of the seat belt by the motor differently according to the state information.

11. The control method according to claim 1, wherein the activating of the pulling operation comprises:
determining whether a brake performs a braking operation; and
activating the pulling operation of the seat belt before the braking operation of the brake.

12. The control method according to claim 1, wherein the activating of the pulling operation comprises:
determining whether or not a seat belt pre-tensioner is activated; and
activating the pulling operation of the seat belt after activation of the seat belt pre-tensioner.

13. The control method according to claim 5, wherein the determining of the state of the vehicle as the at least one travel state comprises:
determining the travel state based on a change in collision speed generated by the collision acceleration sensor with respect to a distance of movement caused by a collision.

14. An active seat belt control apparatus comprising:
a communication unit configured to receive state information about a vehicle;
a controller configured to determine whether to activate a pulling operation of a seat belt using the collected state information; and
a motor configured to perform the pulling operation of the seat belt.

15. The active seat belt control apparatus according to claim 14, wherein the communication unit receives at least one of collision information from a collision sensing apparatus, warning information from a collision warning apparatus, buckle information from a buckle sensor for identifying attachment/detachment of a buckle connected to the seat belt, or travel information from a vehicle body control apparatus.

16. The active seat belt control apparatus according to claim 15, wherein the collision sensing apparatus comprises at least one of a collision acceleration sensor, an overturning acceleration sensor, an overturning angular speed sensor, an acceleration sensor, a gyro sensor, a front impact sensor, or a side impact sensor,
wherein the collision warning apparatus comprises at least one of a front warning sensor, a side warning sensor or a rear warning sensor,
wherein the vehicle body control apparatus collects the state information from at least one of a yaw rate sensor, a roll rate sensor, a steering angle sensor, a wheel speed sensor or a brake pressure sensor,
wherein the acceleration sensor measures an acceleration with respect to at least one of an x-axis, a y-axis, or a z-axis.

17. The active seat belt control apparatus according to claim 16, wherein the controller is configured to:
determine a state of the vehicle as at least one travel state using the collected state information; and
determine to activate the pulling operation when the determined travel state is included in an activation mode of the seat belt,
wherein the activation mode is set to activate the pulling operation of the seat belt.

18. The active seat belt control apparatus according to claim 17, wherein the controller is configured to:
determine the state of the vehicle as at least one of a typical travel state, a rough road travel state, a front collision state, a side collision state, a rear collision state, or an overturning state.

19. The active seat belt control apparatus according to claim 18, wherein the activation mode comprises at least one of the rough road travel state, the front collision state, the side collision state, the rear collision state, or the overturning state.

20. The active seat belt control apparatus according to claim 19, wherein an intensity of the pulling operation is set differently for each of the rough road travel state, the front collision state, the side collision state, the rear collision state, and overturning state.
